(19) United States
(12) Patent Application Publication
(10) Pub. No.: US 2013/0249931 A1
(43) Pub. Date: Sep. 26, 2013

(54) IMAGE PROCESSING DEVICE AND IMAGE PROCESSING METHOD

(71) Applicant: Masami Morimoto, Fuchu-shi (JP)

(72) Inventor: Masami Morimoto, Fuchu-shi (JP)

(21) Appl. No.: 13/671,207

(22) Filed: Nov. 7, 2012

(30) Foreign Application Priority Data
Mar. 22, 2012 (JP) 2012-066371

(51) Int. Cl. G09G 5/02

(52) U.S. Cl. 345/589

(57) ABSTRACT

According to one embodiment, an image processing device configured to correct image signal, includes: a histogram generating module configured to generate histograms for each luminance value for an image that is based on an input image signal; a color emphasizing module configured to determine a color emphasis characteristic through color difference corrections according to the generated histograms; and a gradation converting module configured to generate a corrected image signal by converting gradations of the input image signal according to the determined color emphasis characteristic.

CROSS REFERENCE TO RELATED APPLICATION(S)

The application is based upon and claims the benefit of priority from Japanese Patent Application No. 2012-066371 filed on Mar. 22, 2012, the entire contents of which are incorporated herein by reference.

### BACKGROUND

1. Field

The present invention relates to an image processing device and an image processing method for correcting an image.

2. Description of the Related Art

Image correction may be performed when an image acquired from a storage medium (e.g., disc medium or memory card), a communication medium (e.g., broadcast waves, IP (Internet protocol) network), or the like that is compatible with various coding methods is output to a display device (e.g., LCD (liquid crystal display) or OLED (organic light-emitting diode) display which is a spontaneous light emission device). For example, histogram flattening which is one kind of image correction serves to produce a corrected output image by flattening a distribution of pixel values (e.g., luminance values) of an input image.

In Patent document 1 discloses another kind of image correction. In a system in which video is converted so as to become suitable for the gamut of a display device by dynamic range compression in a color space, the number of pixels that is outside the gamut of the display device are counted from a color histogram of video and the compression ratio is changed so as to decrease that number of pixels.

### BRIEF DESCRIPTION OF THE DRAWINGS

A general configuration that implements the various feature of embodiments will be described with reference to the drawings. The drawings and the associated descriptions are provided to illustrate embodiments and not to limit the scope of the embodiments.

FIG. 1 shows an essential part of the configuration of an image processing device according to an embodiment of the present invention.

FIG. 2 is a functional block diagram of the image processing device (image processing function unit 99) according to the embodiment.

FIG. 3 is a flowchart of the entire process as an essential part of the embodiment.

FIG. 4 is a flowchart of a luminance-by-luminance color difference correction LUT calculation step of the process of FIG. 3.

FIG. 5 is a flowchart of a luminance-by-luminance color difference correction LUT modification (smoothing in the luminance direction) step of the process of FIG. 3.

FIG. 6 is a flowchart of a color difference correction step of the process of FIG. 3.

### DETAILED DESCRIPTION

According to one embodiment, an image processing device configured to correct image signal, includes: a histogram generating module configured to generate histograms for each luminance value for an image that is based on an input image signal; a color emphasizing module configured to determine a color emphasis characteristic through color difference corrections according to the generated histograms; and a gradation converting module configured to generate a corrected image signal by converting gradations of the input image signal according to the determined color emphasis characteristic.

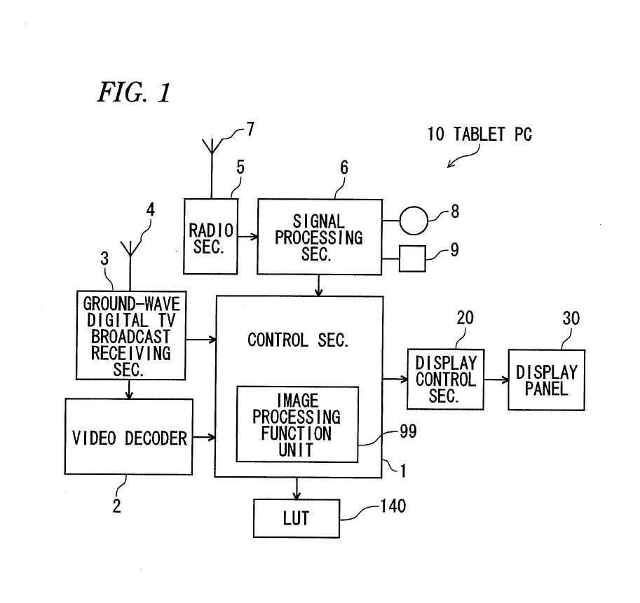

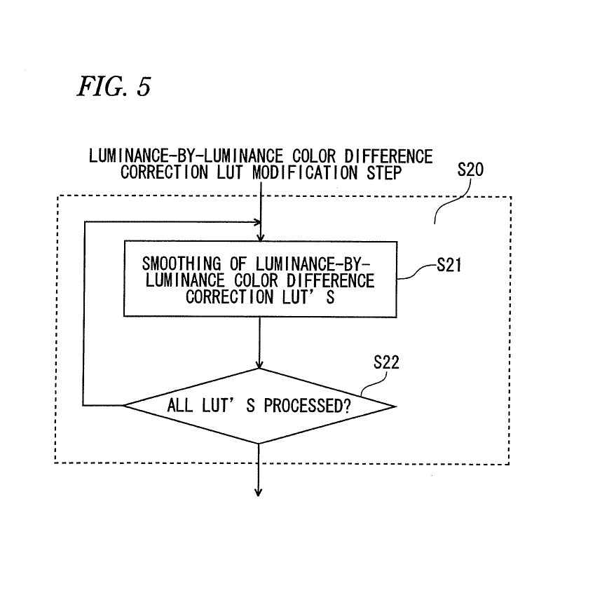

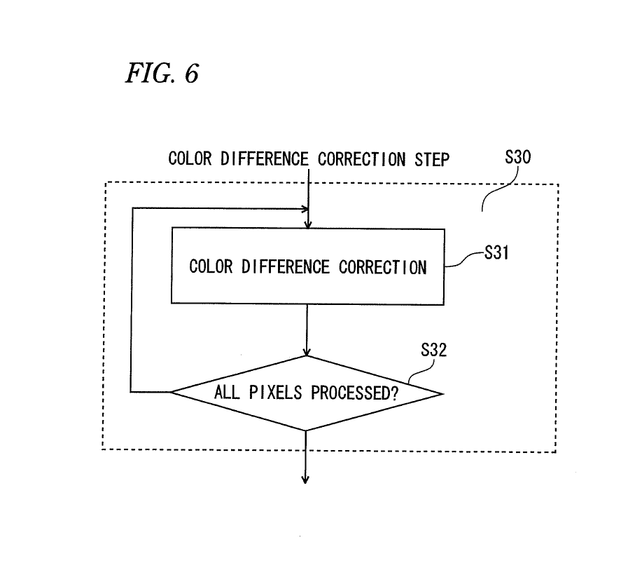

An embodiment of the present invention will be hereinafter described with reference to FIGS. 1-6.

FIG. 1 outlines a tablet PC 10 which is equipped with an image processing device according to the embodiment. The tablet PC 10 is composed of a control section 1 which controls various operations of the tablet PC 10; a video decoder 2 which decodes a coded moving image signal; a ground-wave digital TV broadcast receiving section 3 which demodulates one, on a channel specified by the control section 1, of ground-wave digital TV broadcast signals received by an antenna 4 and thereby takes in TS (transport stream) packets; a radio section 5 which demodulates a radio signal received from a base station by an antenna 7 and thereby obtains a baseband signal; a signal processing section 6 which obtains an audio signal, a control signal, and a data signal by performing decoding processing that complies with CDMA or the like and encodes an audio signal, a control signal, and a data signal to be transmitted via the antenna 7; speakers 9 which outputs the audio signal supplied from the signal processing section 6; a microphone 8 which picks up a voice of a user; and a display control section 20 which controls video display on a display panel 30 on the basis of a moving image signal supplied from the control section 1.

Referring to FIG. 1, the image processing device is composed of an image processing function unit 99 and a gradation conversion lookup table storage unit (LUT) 140. This is because the embodiment assumes that main image processing functions are implemented as programs. The gradation conversion lookup table storage unit 140 may include an input image storage unit (input image buffer) 101, an accumulated histogram storage unit 102, an LUT storage unit 105, a corrected LUT storage unit 107, and an output image storage unit 109 (described later).

The display control section 20 drive-controls the display panel 30 having an LCD (liquid crystal display) panel, an OLED (organic light-emitting diode) panel, a PDP (plasma display panel), or the like on the basis of a corrected moving image signal (described later), whereby a gradation-corrected video image is displayed on the display panel 30.

Next, how the image processing function unit 99 operates will be described.

It is assumed that the image processing function unit 99 according to the embodiment corrects a moving image signal contained in a ground-wave digital TV broadcast signal. Ground-wave digital TV broadcast signals are received by the antenna, and a broadcast signal on a channel specified by the control section 1 is extracted and demodulated by the ground-wave digital TV broadcast receiving section 3. Resulting TS packets are supplied to the video decoder 2. Although a ground-wave digital TV broadcast signal contains a coded audio signal, components necessary for processing an audio signal and pieces of processing performed on the audio signal by them will not be described because the embodiment is directed to the processing performed on a moving image signal.

Among the TS packets extracted by the ground-wave digital TV broadcast receiving section 3, TS packets containing a moving image signal are supplied to the video decoder 2.

The video decoder 2 restores a PES (packetized elementary stream) packet by combining the payloads of plural TS packets supplied from the ground-wave digital TV broadcast receiving section 3, and extracts and decodes a coded moving image signal contained in the payload of the restored PES packet and thereby restores a moving image signal. In ground-wave digital TV broadcasts for tablet PCs, a moving image is coded according to a coding method called MPEG-2. Therefore, the video decoder 2 performs decoding processing that is suitable for this coding method. When a program recorded in a recorder or a moving image DLNA-transferred to the tablet PC 10 is to be viewed, transcoding to H.264 may be performed.

A moving image signal that has been restored in the above manner is supplied to the control section 1 from the video decoder 2 and color correction (described later in detail) and luminance correction are performed on them by the image processing function unit 99.

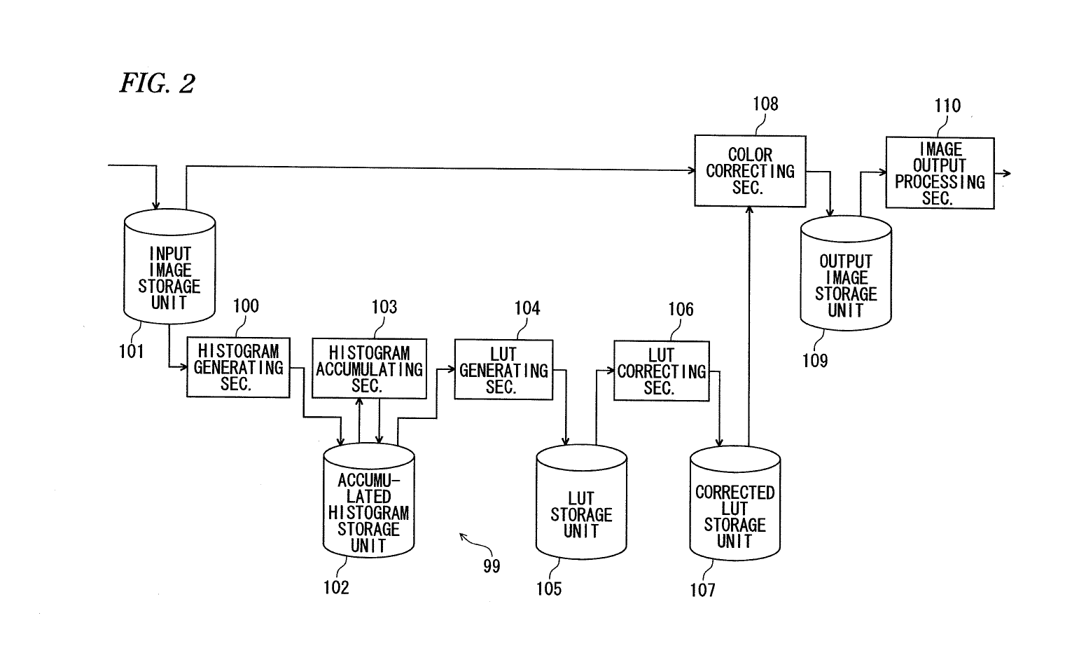

FIG. 2 is a detailed functional block diagram showing pieces of processing performed by the image processing function unit 99. As shown in FIG. 2, the image processing function unit 99 according to the embodiment has a histogram generating section 100, an input image storage unit 101, an accumulated histogram storage unit 102, a histogram accumulating section 103, an LUT (lookup table) generating section 104, an LUT storage unit 105, an LUT correcting section 106, a corrected LUT storage unit 107, a color correcting section 108, an output image storage unit 109, and an image output processing section 110.

The accumulated histogram storage unit 102 includes a luminance-by-luminance color difference histogram buffer and a cumulatively added histogram buffer (described later; not shown). The LUT storage unit 105 includes a luminance-by-luminance color difference correction LUT buffer (not shown), the corrected LUT storage unit 107 includes a corrected luminance-by-luminance color difference correction LUT buffer (not shown), and the output image storage unit 109 includes a color difference signal output buffer (not shown).

A conventional example in which image correction parameters (e.g., luminance correction LUT) are generated on the basis of luminance values of an input image and the luminance values of the input image are corrected using the thus-generated parameters will be described below. However, it is noted that this concept can be applied to not only luminance values but also various other kinds of pixel values. Although in the embodiment each pixel value of an input image is represented in 8-bit length, it can be represented by another number of bits (more or less than 8 bits) as appropriate.

An input image to be corrected by the image processing function unit 99 shown in FIG. 1 is stored in the input image storage unit 101 at least temporarily. The input image is acquired from a storage medium, a communication medium, or the like, decoded if necessary, and stored in the input image storage unit 101. The input image may be either a still image or one of plural frames of a moving image. The input image may even be a local region of a frame in a case that the image processing function unit 99 according to the embodiment corrects a particular local region of a frame adaptively. The input image stored in the input image storage unit 101 is read out by the histogram generating section 100 to generate image correction parameters or read out by the color correcting section 108 to perform a correction using the generated parameters.

The histogram generating section 100 generates a histogram of luminance values of the input image basically according to the following Equation (1):

histonY[Y]+=1(Y=0, . . . , 225) (1)

In Equation (1), histoY is an array whose size corresponds to the bit length of the luminance value Y of the input image (e.g., the size is 256 if the bit length is 8 bits). Equation (1) means that the frequency of a luminance value Y is incremented by one for every subject pixel. The luminance value Y corresponds to a Y signal value if the input image is represented according to the YUV scheme, and corresponds to the maximum one of R, G, and B signal values (see the following Equation (2)) if the input image is represented according to the RGB scheme.

$$Y = \{ \begin{matrix}R & if ( R > G , R > B ) \\ G & if ( G > R , G > B ) \\ B & if ( B > R , B > G )\end{matrix} \qquad ( 2 )$$

The histogramgenerating section 100 stores the generated histogram in the accumulated histogram storage unit 102. The histogram stored in the accumulated histogram storage unit 102 is read out by the histogram accumulating section 103 when necessary, and is also read out by the LUT generating section 104 when necessary.

The LUT generating section 104 reads the histogram from the accumulated histogram storage unit 102 and calculates an accumulated histogram by adding up the frequencies of the histogram. For example, the LUT generating section 104 calculates an accumulated histogram according to the following Equation (3):

$$AccHistoY [ Y ] = {\sum }_{x = 0}^{Y} histoY [ x ] \qquad ( 3 )$$

In Equation (3), AccHistoY[Y] represents accumulated frequencies of the respective luminance values Y. The LUT generating section 104 stores the calculated accumulated histogram in the LUT storage unit 105. The accumulated histogram is stored in the LUT storage unit 105 at least temporarily. The accumulated histogram is stored in the LUT storage unit 105 is read out by the LUT correcting section 106 when necessary.

The LUT correcting section 106 reads the accumulated histogram from the LUT storage unit 105 and normalizes the accumulated histogram. The LUT correcting section 106 generates a luminance correction LUT whose input/output characteristic corresponds to the normalized accumulated histogram according to, for example, the following Equation (4):

$$LUT [ Y ] = YoutMax \times \frac{AccHistoY [ Y ]}{AccHistoY [ 255 ]} \qquad ( 4 )$$

In Equation (4), LUT[Y] represents the output luminance value corresponding to the input luminance value Y and YoutMax represents an output luminance maximum value. YoutMax may be a maximum luminance value (“255” for an 8-bit panel) that can be expressed by the bit length of the output image display device. Where the display device is a spontaneous light emission device such as an OLED display, YoutMax may be a luminance value that is smaller than a maximum luminance value that can be expressed by the bit length of the display device. Limiting the maximum output luminance value in this manner makes it possible to reduce the power consumption of the display panel 30 effectively.

According to Equation (4), the maximum input luminance value (=255) is correlated with YoutMax and each of the other input luminance values is correlated with a value that is scaled (normalized) by YoutMax according to its accumulated frequency. The LUT correcting section 106 stores the generated luminance correction LUT in the corrected LUT storage unit 107. The luminance correction LUT is stored in the corrected LUT storage unit 107 at least temporarily. The luminance correction LUT stored in the corrected LUT storage unit 107 is read out by the color (and luminance) correcting section 108 when necessary.

The color correcting section 108 reads the input image from the input image storage unit 101 and reads the luminance correction LUT from the corrected LUT storage unit 107. The color correcting section 108 corrects the input luminance values Y of the input image to output luminance values Yout using the luminance correction LUT according to the following Equation (5):

Yout=LUT[Y] (5)

The color correcting section 108 stores the corrected image in the output image storage unit 109. The corrected image is stored in the output image storage unit 109 at least temporarily. The corrected image is stored in the output image storage unit 109 is read out by the image output processing section 110 when necessary.

The image output processing section 110 reads the corrected image from the output image storage unit 109, and generates an output image on the basis of color difference values and the corrected luminance values of the respective subject pixels, and outputs the generated output image to the display device (i.e., display control section 20 and display panel 30).

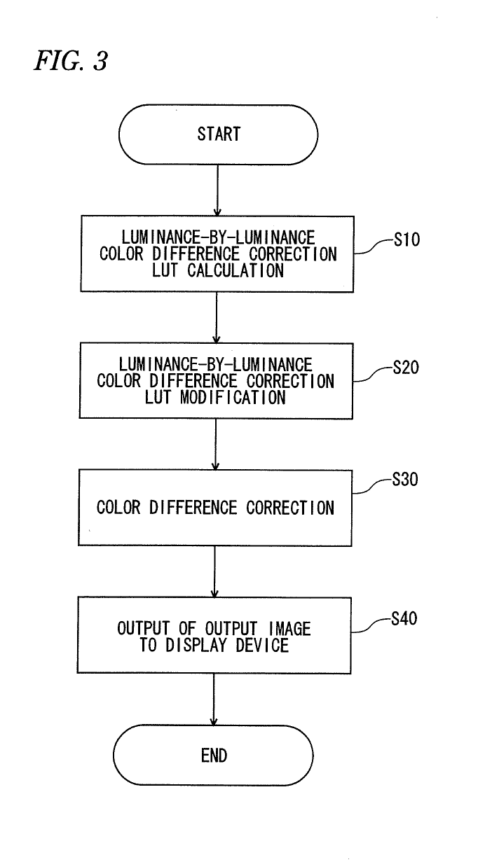

An example operation of the tablet PC 10 (in particular, image processing function unit 99) shown in FIG. 1 will be described with reference to FIGS. 3-6. As shown in FIG. 3, the entire process as an essential part of the embodiment includes three major steps, that is, a luminance-by-luminance color difference correction LUT calculating step S10, a luminance-by-luminance color difference correction LUT modifying step S20, and a color difference correcting step S30. An output image is generated from an input image by steps S10, S20, and S30 and output to the display device.

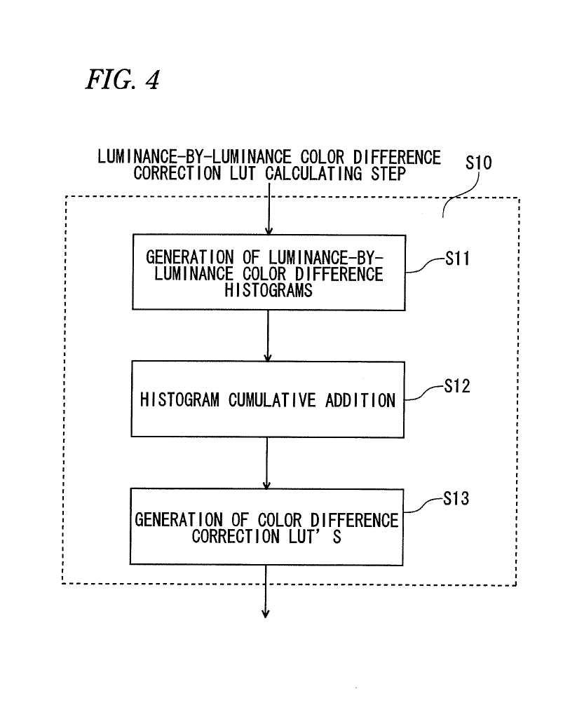

As shown in FIG. 3, first, at step S10, a gradation correction by common histogram flattening as described above is applied to luminance-by-luminance color difference values (a luminance signal and color difference signals stored in respective input image buffers are used). At step S20, the results are smoothed in the luminance direction. At step S30, color difference correction LUTs are generated. At step S40, the image output processing section 110 outputs an output image to the display device. Steps S10, S20, and S30 will be described below in detail with reference to FIGS. 4-6.

As shown in FIG. 4, at a luminance-by-luminance color difference histogram generating step S11 of the luminance-by-luminance color difference correction LUT calculating step S10, the histogram generating section 100 determines, in what is called a more three-dimensional manner, frequencies histoU[x] [U] and histoV[x] [V] of the color differences U and V for each of luminance values x of one frame according to equations similar to Equations (1) and (2), and stores the generated frequencies histoU[x] [U] and histoV[x] [V] in the above-mentioned luminance-by-luminance color difference histogram buffer. In the case of an image of what is called 4k2k, luminance values of about eight million subject pixels are counted in generating histoY. The total of the frequencies of each of histoU[x] [U] and histoV[x] [V] is equal to that of histoY.

At a histogram cumulative addition step S12, the histogram accumulating section 103 adds up the frequencies of the histograms that are input from the luminance-by-luminance color difference histogram buffer and outputs resulting histograms to the cumulatively added histogram buffer. The accumulated histograms AccHistoU[ ] and AccHistoV[ ] are calculated from the histograms histoU[x] [ ] and histoV[x] [ ] according to the following Equations (6) and (7), respectively.

$$\begin{matrix}AccHistoU [ U ] = {\sum }_{y = 0}^{U} histoU [ x ] [ y ] & ( 6 ) \\ AccHistoV [ V ] = {\sum }_{y = 0}^{V} histoV [ x ] [ y ] & ( 7 )\end{matrix}$$

At a color difference correction lookup table generation step S13, the LUT generating section 104 calculates input/output characteristics by normalizing the cumulatively added histograms that are input from the cumulatively added histogram buffer so that for each luminance value x the maximum values of the accumulated histograms become equal to maximum values UoutMax[x] and VoutMax[x] that output color difference values can take.

UoutMax[x] and VoutMax[x] can be determined from saturation values at the time of conversion into RGB signals (“255” for an 8-bit panel).

The color difference correction characteristics lut_u[U] and lut_v[V] are given by the following Equations (8) and (9):

$$\begin{matrix}lut\_u [ U ] = UoutMax [ x ] \times \frac{AccHistoU [ U ]}{AccHistoU [ 255 ]} & ( 8 ) \\ lut\_v [ V ] = VoutMax [ x ] \times \frac{AccHistoV [ V ]}{AccHisto V [ 255 ]} & ( 9 )\end{matrix}$$

These characteristics are stored in the luminance-by-luminance color difference correction LUT buffer as lookup tables that correlate input color difference values U and V with output color difference values Uout and Vout for each luminance value (see Equations (10) and (11)). Step S13 is thus completed.

LUT_{—}U[x] [U]=lut_{—}u[U] (10)

LUT_{—}V[x] [V]=lut_{—}v[V] (11)

The process moves to the luminance-by-luminance color difference correction LUT modification step S20. At a luminance-by-luminance color difference correction LUT smoothing step S21, using inputs from the luminance-by-luminance color difference histogram buffer and the luminance-by-luminance color difference correction LUT buffer, the correction LUT generating section 106 suppresses correction amounts so that the correction amount for each color difference value does not vary to a large extent when the luminance is varied. An output is stored in the corrected luminance-by-luminance color difference correction LUT buffer.

For example, modified luminance-by-luminance color difference correction LUTs CLUT_U[x] [U] and CLUT_V[x] [V] are obtained according to the following Equations (12) and (13) by (arithmetically) averaging color difference correction LUT values corresponding to adjoining luminance values:

$$\begin{matrix}CLUT\_U [ x ] [ U ] = \frac{LUT\_U [ x - 1 ] [ U ] + LUT\_U [ x ] [ U ] + LUT\_U [ x + 1 ] [ U ]}{3} & ( 12 ) \\ CLUT\_V [ x ] [ V ] = \frac{LUT\_V [ x - 1 ] [ V ] + LUT\_V [ x ] [ V ] + LUT\_V [ x + 1 ] [ V ]}{3} & ( 13 )\end{matrix}$$

The averaging operation is not limited to arithmetic averaging. As for the general form of averaging operation, an averaging operation among three normalized values between 0 and 1 is defined as an operation of obtaining an output value between 0 and 1. Among thus-defined operating operations, extreme examples are drastic product and drastic sum. Usually, an averaging operation that is high in harmoniousness, such as harmonic averaging, is employed as appropriate.

If step S21 has been executed for all LUTs (S22: yes), the process moves to the color difference correction step S40 which is executed by the color correcting section 108.

At step S31, using inputs from the corrected luminance-by-luminance color difference correction LUT buffer, the color correcting section 108 calculates corrected color difference signals Uout and Vout for a luminance signal Yin and color difference signals Uin and Vin of each pixel of the input image according to the following Equations (14) and (15) by performing level conversion using the lookup tables CLUT_U and CLUT_V. Outputs are stored in the color difference signal output buffer.

Uout=CLUT_{—}U[Yin] [Uin] (14)

Vout=CLUT_{—}V[Yin] [Vin] (15)

If step S31 has been executed for all pixels (S32: yes), the process moves to the video signal output step S40, where the image output processing section 110 combines the luminance signal Yout and the color difference signals Uout and Vout into a color-emphasized image of one frame and outputs it to the display device.

Advantages of the above-described embodiment will be described below. In the prior art, when an input image is displayed on a display device having a narrow gamut, the chroma of the displayed image is poor as a whole. In contrast, according to the embodiment, improvement is made in a medium chroma range (color difference reproduction ranges) of a display device and the saturation in a high chroma range is suppressed.

Whereas the gradation compression phenomenon in a medium chroma range is prevented by optimization of histograms, chroma correction in which as wide a part as possible of the gamut of a display device is used is enabled even in the case of color components whose color reproduction ranges vary depending on the luminance value as in the YUV color space. For example, in the YUV color space, the color reproduction ranges of blue and violet are wide and the color reproduction range of green is narrow in a low-luminance range. On the other hand, the color reproduction range of green is wide in a high-luminance range. Since the color difference correction is optimized for each luminance value, the embodiment is free of a luminance-dependent color gradation compression phenomenon as occurs in conventional methods when chroma correction is made.

That is, the embodiment is advantageous over the prior art in the following points. Conventionally, although the saturation in a high chroma range is suppressed, no consideration is given to a gradation compression phenomenon in a medium chroma range. The embodiment solves this problem. That is, the embodiment not only prevents a gradation compression phenomenon in a medium chroma range by optimizing color difference histograms for each luminance value but also prevents color gradation compression phenomena in a high chroma range and a medium chroma range even in the case of color components whose color reproduction ranges vary depending on the luminance value as in the YUV color space.

### Supplements to the Gist of Embodiment

(1) Color emphasis is performed using color difference correction LUTs determined by optimizing histograms of color difference signals for each luminance value.

(2) Color difference correction LUTs determined for each luminance value are modified by performing weighted averaging on them.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processing device configured to correct image signal, comprising:
a histogram generating module configured to generate histograms for each luminance value for an image that is based on an input image signal;
a color emphasizing module configured to determine a color emphasis characteristic through color difference corrections according to the generated histograms; and
a gradation converting module configured to generate a corrected image signal by converting gradations of the input image signal according to the determined color emphasis characteristic.

2. The image processing device according to claim 1, wherein
the color emphasizing module determines the color emphasis characteristic further by suppressing variations of color difference correction amounts caused by a luminance variation.

3. The image processing device according to claim 1, further comprising
a display panel configured to display the image.

4. An image processing method of an image processing device for correcting image signal to be used for display by a display panel, comprising:
generating histograms for each luminance value for an image that is based on an input image signal;
determining a color emphasis characteristic through color difference corrections according to the generated histograms; and
generating a corrected image signal by converting gradations of the input image signal according to the determined color emphasis characteristic.

5. The image processing method according to claim 4, wherein
the color emphasis characteristic is determined further by suppressing variations of color difference correction amounts caused by a luminance variation.
